(19) United States
(12) Patent Application Publication
(10) Pub. No.: US 2011/0199486 A1
(43) Pub. Date: Aug. 18, 2011

(54) CUSTOMER BEHAVIOR RECORDING DEVICE, CUSTOMER BEHAVIOR RECORDING METHOD, AND RECORDING MEDIUM

(75) Inventor: Atsushi Moriya, Tokyo (JP)

(73) Assignee: NEC CORPORATION, Tokyo (JP)

(21) Appl. No.: 13/125,496

(22) PCT Filed: Nov. 10, 2009
(86) PCT No.: PCT/JP2009/069119

§ 371 Date: Apr. 21, 2011

(30) Foreign Application Priority Data
Nov. 10, 2008 (JP) 2008-288283

(51) Int. Cl. H04N 7/18

(52) U.S. Cl. 348/150; 348/E07.085

(57) ABSTRACT

A customer behavior recording device includes: an entrance camera (13) which is arranged at the entrance of a facility, such as a store, and images a person who enters the store; an in-facility (in-store) camera (14) which is arranged in the facility and images a person who moves in the facility; and an accounting area camera (15) which is arranged in an accounting area of the facility and images a person who pays money for a commodity. Moreover, the customer behavior recording device includes: an attribute estimation unit which estimates an attribute of the person in accordance with the person imaged by the entrance camera (13); and a personal information recording unit having a file which has imaged the person and a file for recording the time when the image was captured and the attribute estimated by the attribute estimation unit.

### TECHNICAL FIELD

The present invention relates to a customer behavior recording device, a customer behavior recording method and a recording medium, for analyzing the behavior of customers in a facility and gathering data that aids in marketing.

### BACKGROUND ART

A variety of devices have been suggested for gathering data that is the foundation of optimizing positioning of store shelves and product displays. For example, Patent Literature 1 suggests an information system that understands customers' line of flow by attaching RFID reader/writers to shopping cars, and using these RFID reader/writers to read RFID tags positioned at sales counters each time the shopping cart passes the sales counter.

In addition, FIG. 9 in Patent Literature 2 illustrates preparing a camera in digital signage positioned in various locations throughout a store and tracing customers as they move within the store.

### PRIOR ART DOCUMENTS

### Patent Literature

### Patent Literature 1: Unexamined Japanese Patent Application KOKAI Publication No. 2007-257335.

### Patent Literature 2: Unexamined Japanese Patent Application KOKAI Publication No. 2005-251170.

### SUMMARY OF THE INVENTION

### Problems Overcome by the Invention

The information system of Patent Literature 1 is effective in customer behavior analysis, but because this is premised on the existence of a moving object such as a shopping cart that moves along with the customer, the problem exists that this cannot be applied in a store that does not use such moving objects. In addition, Patent Literature 2 suggests the use of cameras attached to digital signage to track customer movements, but does not refer to a concrete means of collecting data to aid in marketing.

In consideration of the foregoing, it is an object of the present invention to provide a customer behavior recording device and a customer behavior recording method for gathering data to aid in marketing from customer behavior in stores, and a recording medium.

### Means for Solving the Problem

The customer behavior recording device according to the present invention includes an entrance camera which is arranged at an entrance of a facility and which images a person entering the facility; in-facility cameras which are arranged inside the facility and which image a person moving inside the facility; and an accounting area camera which is arranged in the accounting area of the facility and which images a person paying to purchase merchandise.

The customer behavior recording method according to the present invention receives images from an entrance camera that images a person entering an entrance of a facility; receives images from an in-facility camera that images a person moving in the facility; receives images from an accounting area camera that images a person accomplishing a payment process in an accounting area; specifies attributes of a person from various images received from the entrance camera, and records customer information including identifying information and determined attribute information; and

specifies a customer from images from the in-facility camera and the accounting area camera and appends information indicating the movement history of the specified customer to customer information corresponding to the customer specified.

The recording medium according to the present invention records a program characterized in executing a process that: receives images from an entrance camera that images a person entering an entrance of a facility; receives images from an in-facility camera that images a person moving in the facility; receives images from an accounting area camera that images a person accomplishing a payment process in an accounting area;

specifies attributes of a person from various images received from the entrance camera, and records customer information including identifying information and determined attribute information; and specifies a customer from images from the in-facility camera and the accounting area camera and appends information indicating the movement history of the specified customer to customer information corresponding to the customer specified.

### Effect of the Invention

The customer behavior recording device according to the present invention is provided with a camera for imaging a customer at the store entrance, at various locations inside the store and at the accounting area, and consequently, it is possible to gather data to aid in marketing by understanding the behavior from when the customer enters the store to the completion of paying for products purchased.

### BRIEF DESCRIPTION OF DRAWINGS

FIG. 1 shows a conceptual arrangement of a store equipped with the customer behavior recording device according to an embodiment of the present invention.

FIG. 2 shows a conceptual external view of small digital signage.

FIG. 3 shows a conceptual external view of a POS register.

FIG. 4 shows an example of the composition of POS information.

FIG. 5 shows a conceptual external view of large digital signage.

FIG. 6 shows a conceptual composition of the customer behavior recording device according to an embodiment of the present invention.

FIG. 7 shows an example of the composition of distribution schedule information.

FIG. 8 is a flowchart for explaining the entrance camera process.

FIG. 9 is an example of a new file created in a customer information recording device.

FIG. 10 is an example of data appended to an existing file.

FIG. 11 is a flowchart for explaining the in-store camera process.

FIG. 12 is an example of data appended to an existing file.

FIG. 13 is an example of data appended to an existing file.

FIG. 14 is a flowchart for explaining the accounting area camera process.

FIG. 15 is an example of data appended to an existing file.

FIG. 16 is a flowchart showing an example of the analysis process.

### BEST MODE FOR CARRYING OUT THE INVENTION

The preferred embodiment for carrying out the present invention is explained below.

This embodiment is intended to facilitate understanding of the principle behind the present invention and is intended to be illustrative and not limiting as to the scope of the present invention. Other embodiments created by appropriately altering the composition of the below embodiment by one skilled in the art are also included within the scope of the present invention

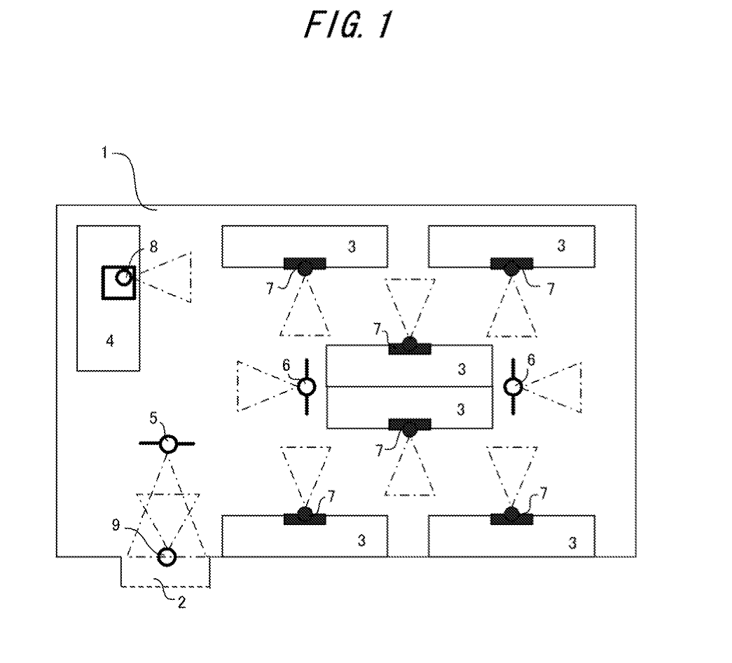

FIG. 1 shows a conceptual arrangement of a store (facility) provided with a customer behavior recording device according to an embodiment of the present invention.

As shown in FIG. 1, a store 1 is a retail store in a self-service format. A customer enters from the entrance 2, moves about within the store 1, takes desired products from shelves 3, pays the purchase price at a register counter 4 and exits from the entrance 2.

A welcome board 5 is positioned facing the customers entering at the entrance 2. The welcome board 5 is a large digital signage displaying a guide to the store and advertising images related to guides such as items of interest, and is provided with a camera for imaging a person in front of the welcome board 5 (a customer who has entered). The composition of the large digital signage is described below.

In addition, a promotional event notification board 6 is positioned in an appropriate location within the store. The promotional event notification board 6 is a large digital signage displaying advertising images relating to various events for sales promotions, and is provided with a camera for imaging customers viewing the promotional event notification board 6.

In addition, small digital signage 7 is attached to the shelves 3. The small digital signage 7 is digital signage that displays advertising images relating to products on the shelves 3 and is provided with a camera for imaging customers looking at the small digital signage 7.

In addition, a POS (Point of Sales) register 8 is provided at the register counter 4. The POS register 8 is a POS (sales time information management system) terminal that records receipt of product payments and also records sales results for each type of product. In addition, near the POS register 8 a camera is provided for imaging customers paying for product purchases at the register counter 4.

In addition, a camera for imaging customers exiting from the store 1 is provided at the entrance 2.

The triangles indicated by dotted lines in FIG. 1 are diagrams conceptually showing the field of vision of each camera (the cameras attached to the welcome board 5, the promotional event notification board 6 and the small digital signage 7, and the camera 9 positioned at the entrance 2).

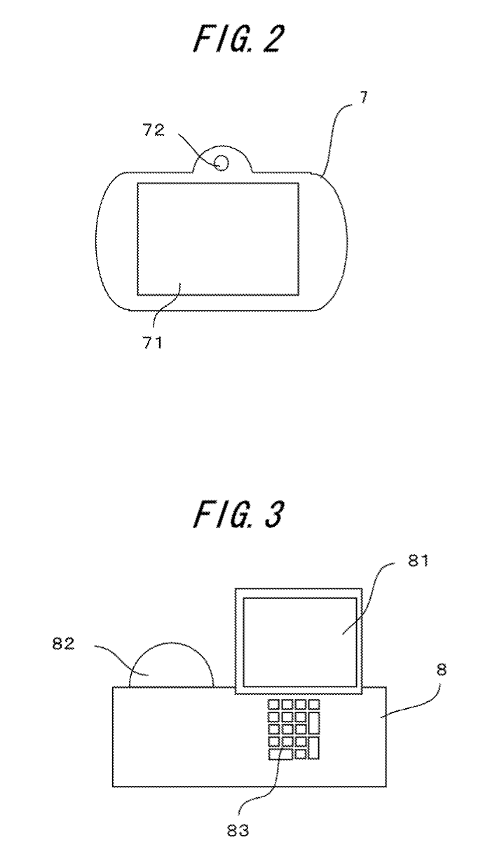

FIG. 2 shows a conceptual external view of the small digital signage 7. As shown in FIG. 2, the small digital signage 7 is provided with a small LCD display 71 and a camera 72. The small LCD display 71 displays advertising images sent from a digital signage distribution device 19 described below, and the camera 72 can image a person standing in front of the shelves 3 and viewing the advertising images.

FIG. 3 shows a conceptual external view of the POS register 8. As shown in FIG. 3, the POS register 8 is a computer equipped with a small LCD display 81, a keyboard 83, an unrepresented recording device, a control unit and a communications unit. Information necessary for the operator of the POS register 8 is displayed on the small LCD display 81. The keyboard 83 is an input device used by the operator to manually enter various types of data.

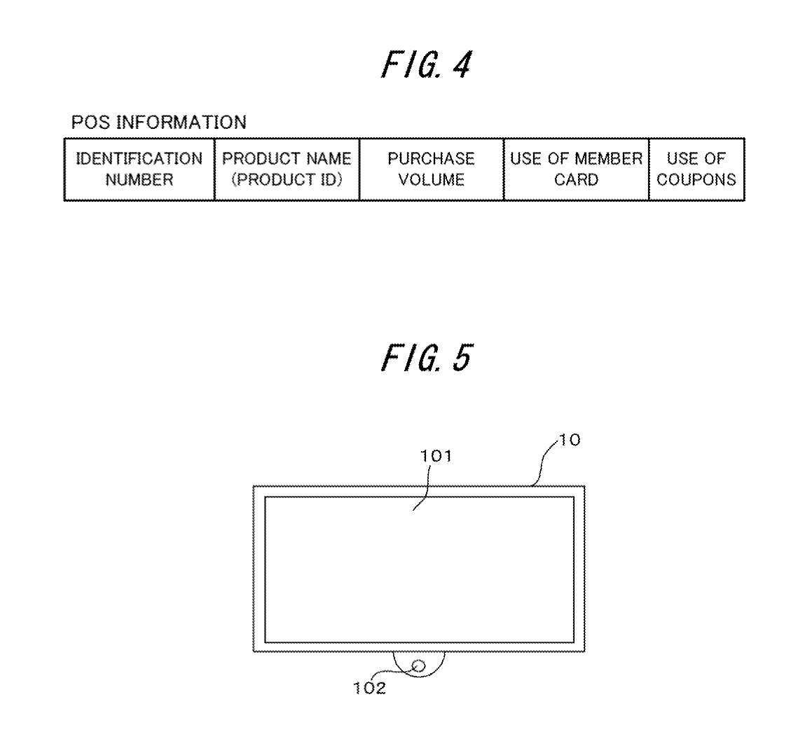

In addition, the POS register 8 stores POS information. FIG. 4 shows an example of the composition of POS information stored in the POS register 8. The POS information is information created each time a customer purchases a product, and is composed of an identification number that is identifying information for the customer, information indicating the name (product ID) of the purchased product, information indicating the purchase volume, information indicating whether a membership card or coupon card was used at the time of purchase, and information indicating the purchase time.

In addition, a camera 82 is positioned near the POS register 8. The camera 82 images a customer who stands in front of the POS register 8 and pays to purchase a product.

FIG. 5 shows a conceptual external view of large digital signage used in the welcome board 5 and the promotional event notification board 6.

As shown in FIG. 5, the large digital signage 10 is provided with a large LCD display 101 and a camera 102. The large LCD display 101 displays advertising images sent from a digital signage distribution device 19 described below, and the camera can image a person who stands in front of the large digital signage 10 and views the advertising images.

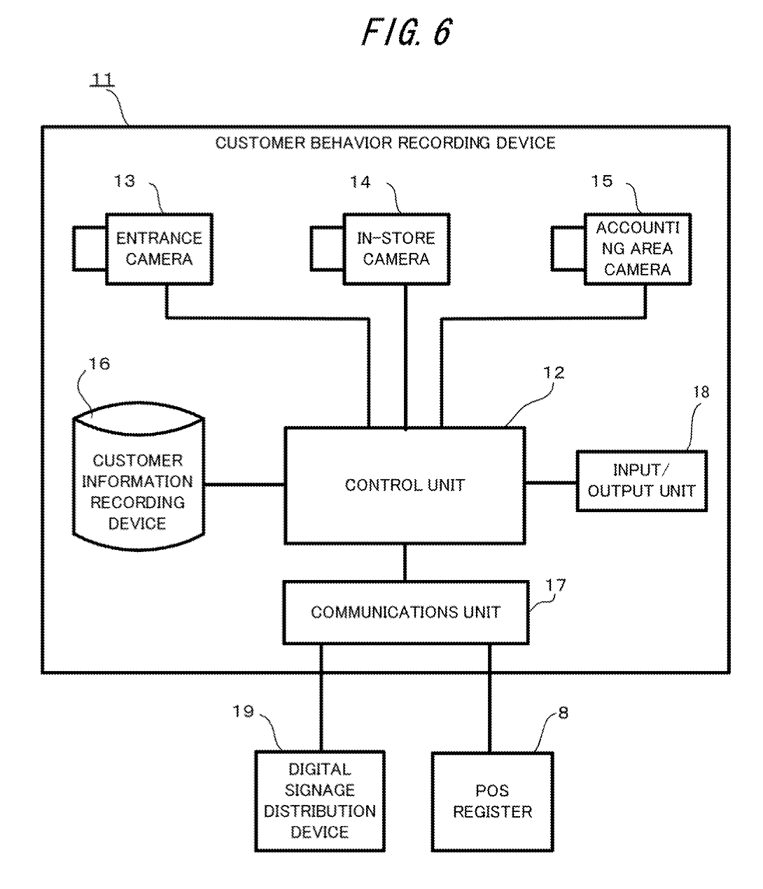

FIG. 6 shows a conceptual composition of the customer behavior recording device according to an embodiment of the present invention. The customer behavior recording device 11 is equipped with a control unit 12, an entrance camera 13, in-store cameras (in-facility cameras) 14, an accounting area camera 15, a customer information recording device 16, a communications unit 17 and an input/output unit 18. The customer behavior recording device 11 is connected to the digital signage distribution device 19 and the POS register 8.

The control unit 12 is a computer that controls the entire customer behavior recording device 11, and is equipped with a CPU (Central Processing Unit), RAM (Random Access Memory), ROM (Read Only Memory) and the like. The CPU executes various types of programs stored in the ROM using the RAM as work space and through this the control unit 12 realizes various processes of the customer behavior recording device 11 described below.

In addition, the control unit 12 is equipped with an RTC (real time clock), and can measure the time a customer enters the store and measure how long a customer stays in the field of view of each camera.

The entrance camera 13 is positioned at the store entrance and is a camera for imaging customers entering the store. In the example shown in FIG. 1, the camera inside the welcome board 5 corresponds to the entrance camera 13.

The in-store cameras 14 are positioned at various locations inside the store and are cameras for imaging customers moving around inside the store. In the example shown in FIG. 1, the cameras 72 installed in the promotional event notification board 6 and the small digital signage 7 correspond to the in-store cameras 14. Identification information (camera ID) is attached to each in-store camera 14.

The accounting area camera 15 is positioned in the accounting area of the store and is a camera for imaging customers paying to purchase merchandise. In the example shown in FIG. 1, the camera 82 arranged near the POS register 8 positioned on the register counter 4 corresponds to the accounting area camera 15.

The customer information recording device 16 is a recording device for storing a file in which is recorded information relating to the image (facial image), attribute information and behavior of each customer analyzed by the customer behavior recording device 11. Detailed contents of this file are described below.

The communications unit 17 communicates with the POS register 8 and the digital signage distribution device 19 and the like via a communications network.

The input/output unit 18 is composed of a keyboard, a display and the like, and inputs data commands and the like to the control unit 12 and outputs (displays) various data in accordance with commands from the control unit 12.

The digital signage distribution device 19 is composed of a server or the like and is a device that distributes advertising images to the welcome board 5, the promotional event notification board 6 and the small digital signage 7.

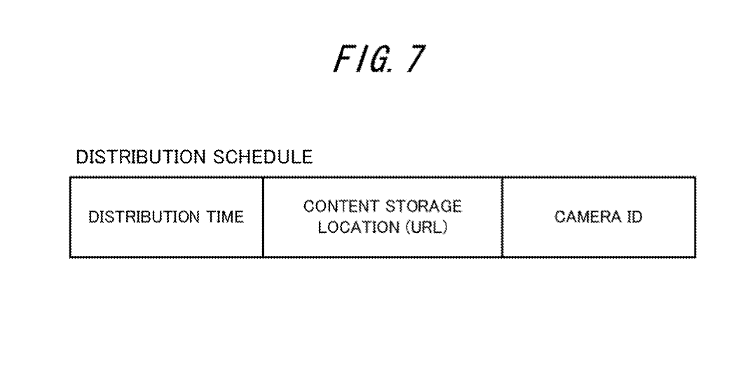

The digital signage distribution device 19 is equipped with an unrepresented database for storing content to be distributed, and an unrepresented schedule memory unit for storing distribution schedule information indicating a prescribed distribution schedule. FIG. 7 shows an example of the composition of the distribution schedule information stored in the schedule memory unit. The distribution schedule information includes a time for distribution, an address (URL (Uniform Resource Locator)) for the storage location of the content to be displayed, and information specifying the camera for distribution (for example, a camera ID). The digital signage distribution device 19 reads content to be distributed from the database and distributes the content read to the welcome board 5, the promotional event notification board 6 and the small digital signage 7 in accordance with the clock time and the distribution schedule.

Next, the action of a customer behavior recording device 11 having the above composition will be described.

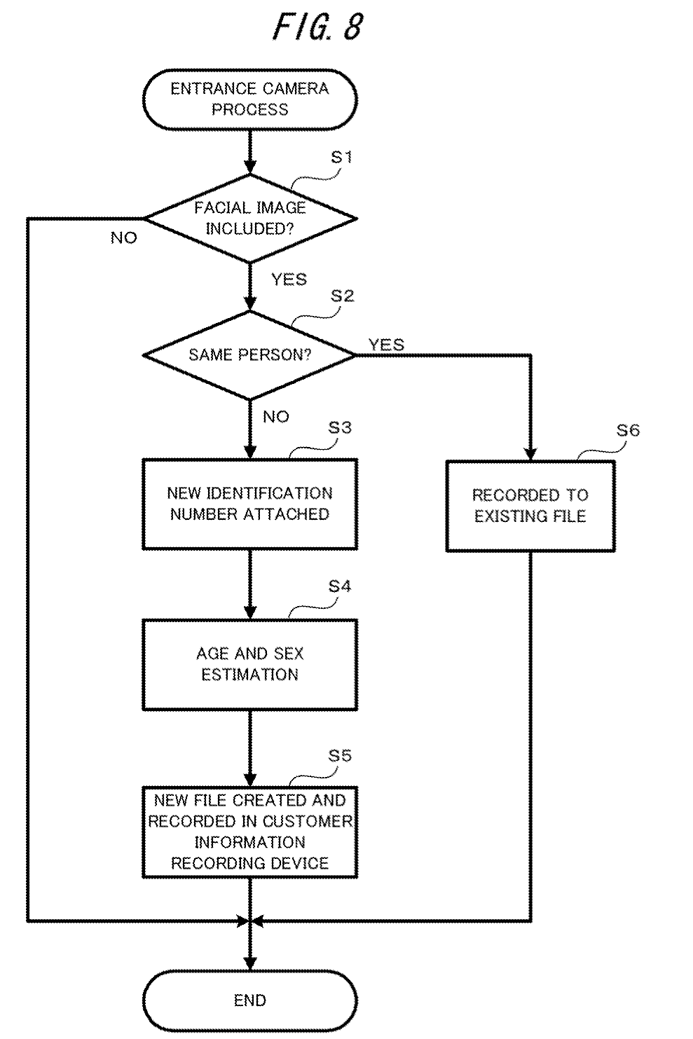

First, the entrance camera process will be explained with reference to the flowchart of FIG. 8.

The entrance camera 13 shoots images in front, for example taking frame images with a frame period of 1 second, and distributes these frame images to the control unit 12 along with time information of shooting these frame images. Upon receiving frame images from the entrance camera 13, the control unit 12 executes the process (entrance camera process) shown in FIG. 8 for each frame image received.

First, the control unit 12 determines using pattern recognition technology or the like whether or not the facial image of a customer is included in the supplied frame image (step S1). In step S1, an arbitrary pattern recognition technology can be used as long as a determination can be made as to whether or not the facial image of a customer is included in the image (frame image) captured by the entrance camera 13.

When it is determined that the facial image of a customer is not included in the supplied frame image (step S1; No), the control unit 12 concludes this process.

When it is determined that the facial image of a customer is included in the supplied frame image (step S1; Yes), the control unit 12 compares that customer facial image and file images stored in the customer information recording device 16, and determines whether or not there is one that matches, that is to say whether or not that customer (the customer imaged by the entrance camera 13) is the same person as a person in the file (step S2). In step S2, for example the degree of matching between images may be computed by executing a prescribed image matching process, and determination of a matching person can be made when the computed degree of matching is greater than a threshold value.

If the image of a matching person does not exist in the customer information recording device 16 (step S2: No), the control unit 12 appends a new identifying number to this customer (step S3).

Next, the control unit 12 estimates the attributes of the customer (sex and age) on the basis of the facial image of that customer (step S4). The method of estimating the sex and age is arbitrary. For example, the age and sex of the customer may be estimated by seeking model data on the basis of multiple types of characteristic parameters obtained from facial images for each age and sex, combining characteristic parameters obtained from the facial image captured this time, and estimating the age and sex corresponding to the model data determined to be most applicable.

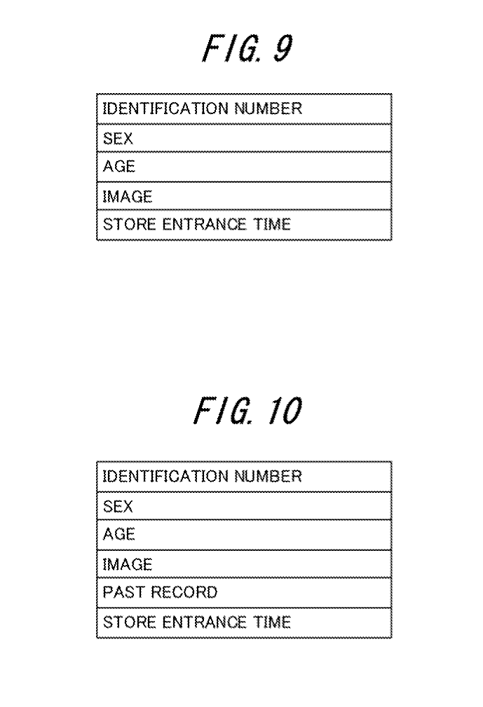

Next, the control unit 12 creates a new file, records this in the customer information recording device 16 (step S4) and concludes the process. FIG. 9 is a drawing showing an example of a new file created in step S4. In the new file created in step S4, the identification number of the customer appended in step S3, the sex and age of the customer estimated in step S4, the facial image of the customer captured by the entrance camera 13 and the entrance time of that customer (the time the customer was captured by the entrance camera 13) are recorded, as shown in FIG. 9.

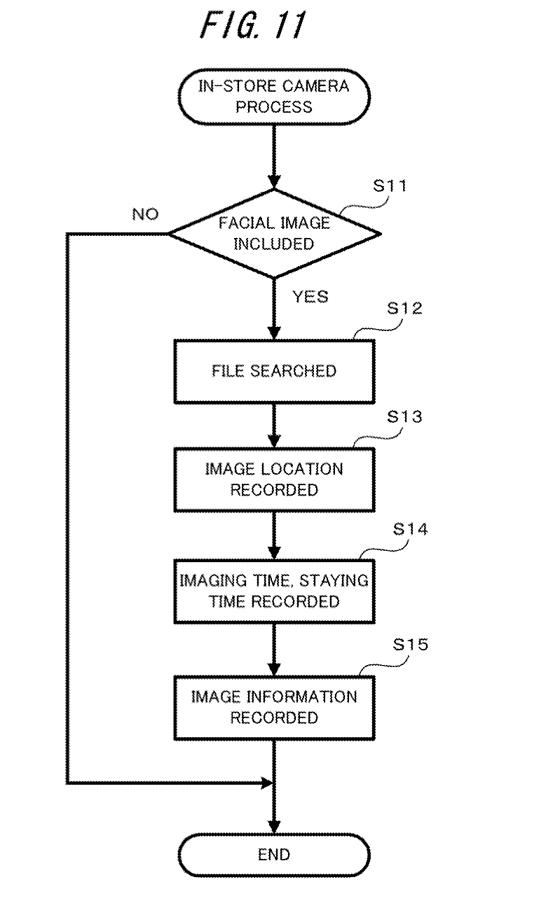

On the other hand, if the image of the same person is recorded in the customer information recording device 16 (step S2; yes), in other words if there is an existing file recording the same customer as the person whose facial image was captured by the entrance camera 13, the control unit 12 records the current entrance time in addition to (added to) the past record of that existing file (the record of the times that customer previously came to the store), as shown in FIG. 10, and the process concludes.

Next, the in-store camera process will be described with reference to the flowchart in FIG. 11.

An in-store camera 14 captures images in front and for example obtains frame images with a frame period of one second, and sends the time information at which that frame image was captured along with the camera ID to the control unit 12. Upon receiving frame images from the in-store camera 14, the control unit 12 accomplishes the process shown in FIG. 11 (in-store camera process) for each frame image received.

First, the control unit 12 determines using pattern recognition technology or the like whether or not the facial image of a customer is included in the supplied frame image (step S11). When it is determined that the facial image of a customer is not included in the supplied frame image (step S11; No), the control unit 12 concludes this process. When it is determined that the facial image of a customer is included in the supplied frame image (step S11; Yes), the control unit 12 searches file images stored in the customer information recording device 16, and detects a file where the image of a person matching this customer (the customer captured by the in-store camera 14) is recorded (step S12).

Next, the control unit 12 records the camera ID (i.e., information indicating the place where the customer was stopping) of the in-store camera 14 that captured that customer in the aforementioned file detected in step S12 (step S13).

Next, the control unit 12 records in that file the time when that customer was captured by the in-store camera 14 (in other words, the time when that customer was stopping in the aforementioned location) and the time that that customer stayed in the field of vision of the in-store camera 14 (staying time) (step S14). For example, the control unit 12 may seek as the staying time the frame period multiplied by the number of frame images in which the customer was continuously captured, out of the frame images successively received from the in-store camera 14.

Furthermore, the control unit 12 specifies on the basis of the distribution schedule stored in the schedule memory unit the advertising images (in other words, the images to be watched by that customer) to be displayed on the small digital signage 7 or the promotional event notification board 6 equipped with the in-house camera 14 that captured that customer. Furthermore, the control unit 12 reads information specifying the specified advertising images (for example, the address (URL) of the storage position of the advertising images) from the digital signage distribution device 19 and records the aforementioned file (step S15).

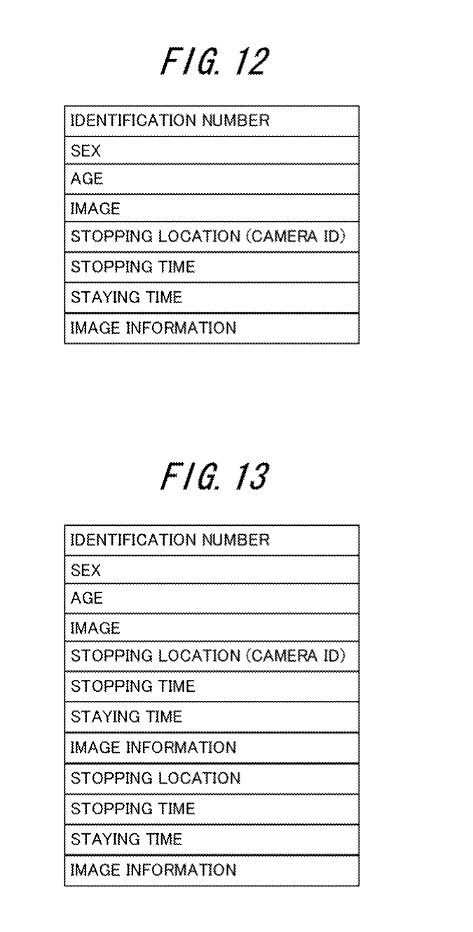

FIG. 12 shows a file in which various data has been written through the in-store camera process. As shown in FIG. 12, in this file image information specifying the camera ID of the in-store camera 14 that captured the customer recorded in step S13, the imaging time recorded in step S14 and the time the customer stayed in the field of vision of that in-store camera 14 (the staying time), and the images displayed on the promotional event notification board 6 or the like equipped with that in-store camera 14 when the customer recorded in step S15 is staying in the field of vision of that in-store camera 14 (in other words, the images watched by the customer) is written in the existing file. In addition, as shown in FIG. 13, this written information is appended to the aforementioned file each time that customer is imaged by the in-store camera 14 (in other words, each time the customer stands in front of the promotional event notification board 6). In this manner, with the customer behavior recording device 11 the line of movement of the customer in the store and the time spent viewing advertising images on the digital signage are successively recorded.

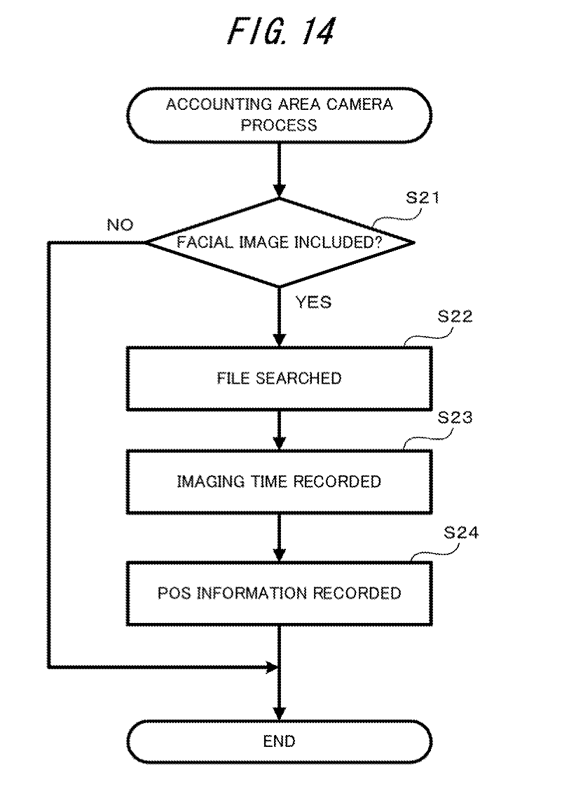

Next, the accounting area camera process will be explained with reference to the flowchart in FIG. 14.

The accounting area camera 15 captures images in front and for example obtains frame images with a frame period of one second, and sends the time information at which that frame image was captured to the control unit 12. Upon receiving frame images from the accounting area camera 14, the control unit 12 accomplishes the process shown in FIG. 14 (accounting area camera process) for each frame image received.

First, the control unit 12 determines using pattern recognition technology or the like whether or not the facial image of a customer is included in the supplied frame image (step S21). When it is determined that the facial image of a customer is not included in the supplied frame image (step S21; No), the control unit 12 concludes this process. When it is determined that the facial image of a customer is included in the supplied frame image (step S21; Yes), the control unit 12 searches file images stored in the customer information recording device 16, and detects a file where the image of a person matching this customer (the customer captured by the accounting area camera 14) is recorded (step S22).

Next, the control unit 12 records the time when that customer was imaged (in other words, the time when that customer stood in front of the POS register 8) in the aforementioned file (step S23).

Next, the control unit 12 accesses the POS register 8, acquires (or is supplied with) POS information about that customer (that is to say, the name (product ID) of products that customer purchased, information relating to volume, and information indicating whether or not a member card was used and whether or not coupons were used), this is recorded in the aforementioned file (step S24) and the process concludes.

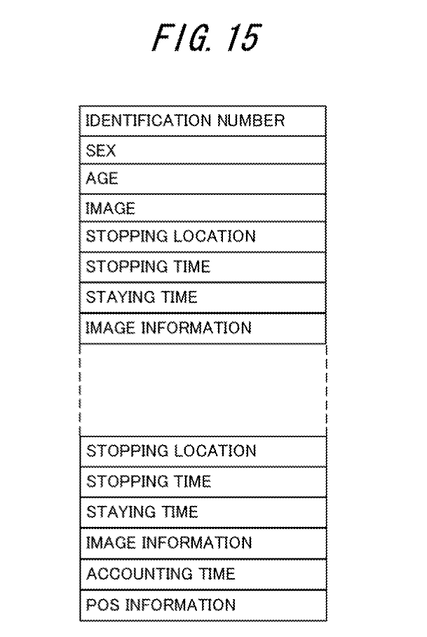

FIG. 15 shows a file in which various data has been written by the accounting area camera process. As shown in FIG. 15, after recording information indicating the movement path of the customer in the store (stopping locations, stopping times) and information related to viewing digital signage advertising images (staying time, image information) in the file, the POS information acquired in step S24 is recorded (information relating to the names and volume of products purchase by that customer). That is to say, when and where that customer who entered the store 1 stopped, for what length of time the customer watched what advertising images and finally what the customer purchased are recorded.

When the camera images the customer going through the entrance 2 and exiting the store 1, the control unit 12 records that time in the aforementioned file as the exit time. Specifically, the control unit 12 analyzes the image captured by the camera 9, and when the facial image of the customer is included in that image, it is determined that the customer has exited the store, and that time is recorded in that customer's file as the exit time.

With the customer behavior recording device 11, it is possible to accumulate information relating to the track (movement line) in the store 1 from when the customer enters the store 1, purchases products and until the customer leaves the store, and the names and volume of products purchased by the customer, the contents of images on the digital signage viewed by the customer while in the store 1 and the sex and age estimation results for that customer. In addition, analyzing this information is useful in improving product displays in the store 1, the arrangement of shelves 3 and images displayed on the digital signage.

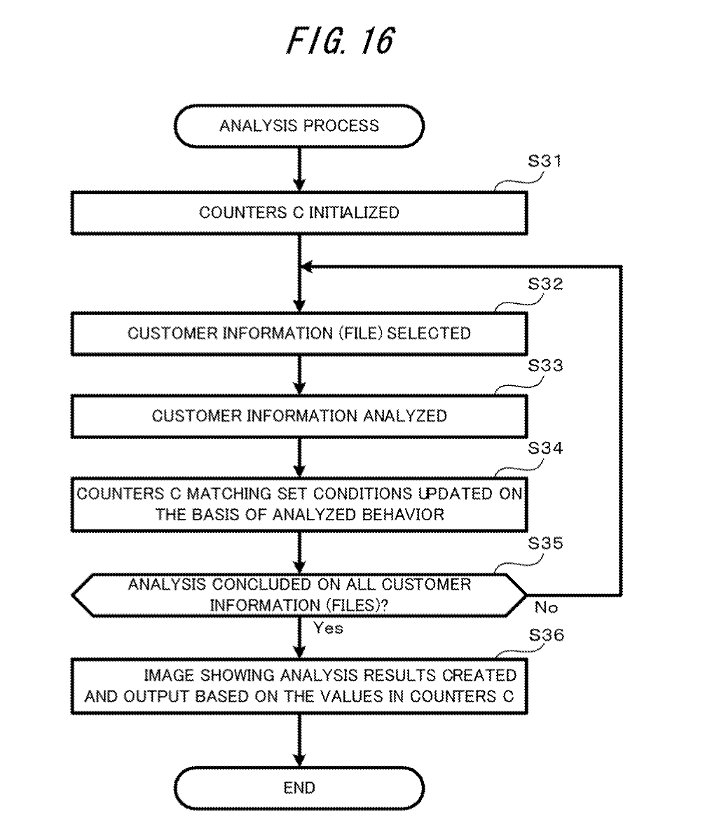

Next, one example of the procedures for analyzing customer information accumulated in this manner will be explained with reference to the flowchart in FIG. 16.

As assumptions, suppose that the control unit 12 is equipped by default with a counter Ca indicating the number of customers who enter the store, a counter Cb indicating the number of women who enter the store, and so on, up to a counter Cd indicating the number of people in their teens who have entered the store and a counter C2 indicating the number of people in their 20s who have entered the store.

On the other hand, the user operates the input/output unit 18, designs arbitrary conditions in the control unit 12 as needed and indicates to the control unit 12 to analyze customer information using designed conditions. For example, conditions to be focused on are appropriately designed, such as (age: “teens” or “twenties”) and (sex: female) and (time entered store: 10:00 to 14:00) and (after stopping at A, moved to B, with staying time C at A). The control unit 12 appropriately sets the counter Ca and so forth corresponding to the designed conditions.

In response to instructions for analysis from the user, the control unit 12 starts the analysis process shown in FIG. 16. First, the control unit 12 initializes each set counter C to 0 (step S31).

Next, the control unit 12 selects the file of one customer from the customer information recording device 16 (step S32), analyzes customer behavior from that file (step S33), determines whether or not this is a customer falling under the various conditions designed by the user and updates each counter C corresponding to the applicable conditions (step S34).

Next, the control unit 12 determines whether or not analysis has concluded on all customer information (files) (step S35), and if there is customer information for which analysis has not concluded (step S35; No), selects the next customer information (file) (step S32) and similarly conducts analysis.

On the other hand, if analysis has concluded for all customer information (step S35; Yes), the control unit generates an image showing the analysis results found from the values of the counters C, and outputs this to the input/output unit 18 (step 36).

With this kind of composition, the behavior of a customer in a store is analyzed from various information obtained by imaging the customer, so it is possible to gather data to aid in marketing.

The method of analyzing customer information is not limited to the above-described method, for it is possible to conduct analysis using other methods. For example, the user can input via the input/output unit 18 customer search conditions to be acquired and can specify customer conditions. The control unit may then respond to that specification, create queries for searching customer information (files), acquire customer files matching these conditions by executing the queries and make a summary display of this on the input/output unit 18.

The present invention is not limited to the above-described embodiment, for various variations and applications are possible.

For example, in the present embodiment, an example was described in which the customer behavior recording device 11 of the present invention is installed in a store, but the application locations of the present invention are not limited to stores. This invention can be applied to various types of facilities, including stores, such as game centers, amusement parks and the like.

In addition, the system composition (hardware composition and software composition) and process ordering of the customer behavior recording device 11 can be appropriately changed as long as the same functions can be realized.

In addition, in the entrance camera process, the sex and age are estimated from facial images as the customer attributes and are stored in files, but various other types of information that can be determined from facial images such as the race of the customer may be estimated and stored in files.

In addition, the entrance camera 13, the in-store cameras 14 and the accounting area camera 15 need not image only the face of the customer, and for example can image arbitrary areas, such as the torso or the entire body of the customer. In addition, the entrance camera 13, the in-store camera 14 and the accounting area camera 15 can be provided with a motion sensor, a heat sensor, an infrared sensor of the like. When that sensor detects a customer, the camera equipped with that sensor is operated and can image the customer. In addition, the entrance camera 13, the in-store camera 14 and the accounting area camera 15 can capture still images at arbitrary time intervals (e.g., three-second intervals). The control unit 12 can determine the presence of customers on the basis of multiple still images thus captured.

This application claims the benefit of Japanese Patent Application No. 2008-288283, the entire disclosure of which is incorporated by reference herein.

Legend
1 store
2 entrance/exit
3 shelves
4 register counter
5 welcome board
6 promotional event notification board
7 small digital signage
8 POS register
9 camera
10 large digital signage
11 customer behavior recording device
12 control unit
13 entrance camera
14 in-store camera (in-facility camera)
15 accounting area camera
16 customer information recording device
17 communications unit
18 input/output unit
19 digital signage distribution device
71 small LCD display
72 camera
81 small LCD display
81 camera
83 keyboard
101 large LCD display
102 camera

1. A customer behavior recording device, comprising:
an entrance camera which is arranged at an entrance of a facility and which images a person entering the facility;
in-facility cameras which are arranged inside the facility and which image a person moving inside the facility; and
an accounting area camera which is arranged in the accounting area of the facility and which images a person paying to purchase merchandise.

2. The customer behavior recording device according to claim 1, further comprising:
an attribute estimation unit that estimates the attributes of a person on the basis of images of the person imaged by the entrance camera; and
a personal information recording unit that has files where images captured of the person, the time the image is captured and attributes estimated by the attribute estimation unit are recorded.

3. The customer behavior recording device according to claim 1, wherein the entrance camera is camera-equipped digital signage arranged at an entrance of the facility.

4. The customer behavior recording device according to claim 2, further comprising an image reference unit wherein images of people captured by the entrance camera are compared to images captured previously and recorded in the personal information recording unit, and when said person is the same person as the person in an image recorded in the personal information recording unit, the time said person was imaged is recorded in the file of the person considered the same person in the personal information recording unit, and when there is no image of a person matching said person in the images captured previously, a new file is created in the customer behavior recording device and the image captured of said person, the time the image was captured and attributes estimated by the attribute estimation unit are recorded.

5. The customer behavior recording device according to claim 4, wherein the image reference unit compares images of people captured by the in-facility camera to images recorded in the personal information recording unit, and records the time a person was imaged by the in-facility cameras in the file of a person considered to be the same person as that person of the personal information recording unit.

6. The customer behavior recording device according to claim 5, wherein the in-facility camera is a camera on camera-equipped digital signage arranged in the facility and captures images of a person viewing the camera-equipped digital signage, and
records in the personal information recording unit information relating to advertising images on the digital signage watched by said person.

7. The customer behavior recording device according to claim 5, wherein the image reference unit compares images of people captured by the accounting area camera to images recorded in the personal information recording unit, and records the time a person was imaged by the accounting area camera in the file of a person considered to be the same person as said person of the personal information recording unit.

8. The customer behavior recording device according to claim 5, wherein the accounting area camera is a camera attached to a POS register device, and
information relating to merchandise purchased by a person imaged by the accounting area camera is input from the POS register device and is recorded in the file of said person in the personal information recording unit.

9. A customer behavior recording method that:
receives images from an entrance camera that images a person entering an entrance of a facility;
receives images from an in-facility camera that images a person moving in the facility;
receives images from an accounting area camera that images a person accomplishing a payment process in an accounting area;
specifies attributes of a person from various images received from the entrance camera, and records customer information including identifying information and determined attribute information; and
specifies a customer from images from the in-facility camera and the accounting area camera and appends information indicating the movement history of the specified customer to customer information corresponding to the customer specified.

10. A computer-readable recording medium on which is recorded a program characterized in executing a process that:
receives images from an entrance camera that images a person entering an entrance of a facility;
receives images from an in-facility camera that images a person moving in the facility;
receives images from an accounting area camera that images a person accomplishing a payment process in an accounting area;
specifies attributes of a person from various images received from the entrance camera, and records customer information including identifying information and determined attribute information; and
specifies a customer from images from the in-facility camera and the accounting area camera and appends information indicating the movement history of the specified customer to customer information corresponding to the customer specified.
